(19) United States
(12) Patent Application Publication
(10) Pub. No.: US 2014/0272856 A1
(43) Pub. Date: Sep. 18, 2014

(54) SYSTEM AND METHOD FOR PHYSICAL TRAINING THROUGH DIGITAL LEARNING

(71) Applicants: Tammy Dandino, Maplewood, NJ (US); Thomas Regan, North Andover, MA (US); Timothy Wikstrom, Prairie Village, KS (US)

(72) Inventors: Tammy Dandino, Maplewood, NJ (US); Thomas Regan, North Andover, MA (US); Timothy Wikstrom, Prairie Village, KS (US)

(21) Appl. No.: 14/216,385

(22) Filed: Mar. 17, 2014

Related U.S. Application Data
(60) Provisional application No. 61/794,745, filed on Mar. 15, 2013.

(51) Int. Cl. G09B 19/00

(52) U.S. Cl. CPC G09B 19/00
USPC 434/247

(57) ABSTRACT

A system and method for receiving sensor information regarding a user's physical expression, processing the sensor information using an analysis module and stored data, and displaying real-time or delayed training output to the user. The system may further include utilizing a hub module for communicating with external systems such as external computer systems and storage media for reasons including, without limitation, to receive updates for the analysis module and stored data, request additional analysis of the sensor information, receive a result from the external system, and retrieve data and files from the external system for use as part of training output.

### CROSS-REFERENCE TO RELATED APPLICATION

This Patent Application claims priority to U.S. Provisional Patent Application Ser. No. 61/794,745 titled System and Method for Physical Training Through Digital Learning, and filed Mar. 15, 2013, the entire contents of which is incorporated herein by reference.

### BACKGROUND

1. Field

The present inventive concept generally relates to a system and method for training users about physical expression using digital learning techniques. In an embodiment, the present inventive concept more particularly concerns a system and method to collect, analyze, and provide training output for improvement of physical expression.

2. Discussion of Related Art

There are a number of existing strategies for training individuals about successfully giving presentations, performing in front of others, and otherwise managing their physical expressions. Certain existing strategies rely on live, in-person instructors to provide rapid feedback, or on slower processes including those involving recordings and playbacks that lead to feedback for training. These strategies require direct input from instructors, which can be embarrassing for beginner users, and rely on the expertise and experience of a single or small group of instructors retained to provide feedback to such users, which can lead to high demand for and shortage of the time and energies of quality instructors. Other strategies may include training videos and other general instructional materials, but such videos are not personalized or responsive to individual problems.

Accordingly, there is a demand for a system and method configured to provide improved personalized training for users seeking to improve physical expression skills.

### SUMMARY

An embodiment of the present inventive concept remedies the aforementioned problems by providing a system and method configured to receive sensor information about a user's physical expression, analyze same, and generate training output without the need for in-person instruction.

It is an object of the present inventive concept to provide a system and method that avoids the trouble of, and potential anxiety resulting from, scheduling in-person instruction to obtain training for managing physical expressions.

It is an object of the present inventive concept to provide a system and method to provide real-time or near real-time training without the need for in-person instruction.

It is an object of the present inventive concept to provide a system and method for digital training capable of relying on objective data, rules developed from observation of multiple persons, and/or models for physical expression developed externally, rather than relying solely on more subjective in-person instruction.

It is an object of the present inventive concept to provide a system and method to provide personalized training without the need for in-person instruction.

The aforementioned may be achieved in an aspect of the present inventive concept by providing a system including a computer, a sensor configured to detect physical expressions of a user and provide sensor information regarding the physical expressions to the computer, an analysis module configured to analyze the sensor information and generate a first result, and a display configured to transmit training output to the user.

The system may also include stored data for use by the analysis module. The stored data may include information observed about the relevant physical expressions of a number of other people, accumulated information about the user's past performance(s), and/or information derived from or consisting of a model or theory of successful physical expression. The stored data may result from one or a combination of information stored at installation, acquired thereafter via a hub module, and learned and stored through use of the sensor.

The system may further include a hub module configured to manage communications between the computer and external systems such as those residing in computer systems and memory devices. The training output may be based on one or both of the first result generated by the analysis module and a second result obtained via the hub module.

The aforementioned may be achieved in another aspect of the present inventive concept by providing a method for providing physical expression training to a user including the steps of receiving sensor information regarding the physical expressions of the user, analyzing the sensor information using a computer executing an analysis module to generate a first result, and transmitting training output to the user via a display.

The method may further include analyzing the sensor information in conjunction with stored data and/or a second result received from a hub module. The computer and its analysis module may be updated using the hub module as well. Still further, the second result may include feedback provided by third party users following review of the sensor information.

Additional objects, aspects, advantages, and utilities of the present inventive concept will be set forth in part in the description which follows and, in part, will be obvious from the description, or may be learned by practice of the present inventive concept.

The foregoing is intended to be illustrative and are not meant in a limiting sense. Many features and subcombinations of embodiments of the present inventive concept may be made and will be readily evident upon a study of the following specification and accompanying drawings comprising a part thereof. For example, the system and method of the present inventive concept may be employed to help with users' efforts in physical therapy, physical fitness, hair cutting, negotiation, singing and other activities having components that rely on physical expression, without deviating from the spirit of the present inventive concept. These features and subcombinations may be employed without reference to other features and subcombinations.

### BRIEF DESCRIPTION OF THE DRAWINGS

Embodiments of the present inventive concept are described in detail below with reference to the attached drawing figures, wherein:

FIG. 1 is a flowchart illustrating a system of an embodiment of the present inventive concept;

FIG. 2 is a flowchart illustrating a process of an embodiment of the present inventive concept; and

FIG. 3 is a flowchart illustrating the primary components for creating a learning plan in an embodiment of the present inventive concept.

The drawing figures do not limit the present inventive concept to the specific examples disclosed and described herein. The drawings are not necessarily to scale, emphasis instead being placed upon clearly illustrating the principles of the present inventive concept.

### DETAILED DESCRIPTION

The following detailed description references the accompanying drawings that illustrate embodiments of the present inventive concept. The illustrations and description are intended to describe aspects of the present inventive concept in sufficient detail to enable those skilled in the art to practice the present inventive concept. Other components can be utilized and changes can be made without departing from the scope of the present inventive concept. The following detailed description is, therefore, not to be taken in a limiting sense. The scope of the present inventive concept is defined only by the appended claims, along with the full scope of equivalents to which such claims are entitled.

In this description, references to “one embodiment,” “an embodiment,” or “embodiments” mean that the feature or features being referred to are included in at least one embodiment of the present inventive concept. Separate references to “one embodiment,” “an embodiment,” or “embodiments” do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present inventive concept can include a variety of combinations and/or integrations of the embodiments described herein. Likewise, references to “exemplary” is used exclusively herein to mean “serving as an example, instance, or illustration.” Any embodiment described herein as “exemplary” is not necessarily to be construed as preferred or advantageous over other embodiments.

The present inventive concept utilizes a system to provide physical expression training to users. In an aspect of the present inventive concept, the system addresses the shortcomings of related art and provides real-time training output based on results of analyzing the user's physical expressions made mere moments before without the need for an in-person instructor. In another aspect of the present inventive concept, the system communicates data and/or results to external computer systems and experts so that additional analysis or instructions can be used to provide the training output.

Turning to FIG. 1, a system of an embodiment of the present inventive concept is illustrated including a computer 10 in communication with a sensor 12 and a display 14. The sensor 12 receives input 15 relating to a users physical expressions and transmits sensor information to the computer 10. Following processing of the sensor information to create results, the display 14 transmits training output to the user. In a preferred embodiment, the sensor 12 is incorporated into the same housing as the display 14, such as where the sensor 12 is a video camera embedded in a personal computer having a screen and speaker operating as the display 14.

The sensor 12 may be a microphone, still or video camera, infrared sensor, or similar device that is configured to detect input 15, that is, detectable evidence of the physical expressions of the user. Physical expressions emanate from the body and are detectable in the physical world, and include without limitation the movement of body parts and the user's gestures, the relative position of body parts and the user's postures, sounds made by the user, facial expressions, and other static and dynamic detectable physical properties such as infrared emanations given off by the user's body indicating things like blood flow through and location at any given time within the user's body or electrical activity in the brain and nervous system. The sensor 12 may transmit raw sensor information it detects to the computer 10 and/or a hub module, or may be configured to utilize software and/or hardware to filter, perform pre-processing and/or formatting prior to transmitting the sensor information to the computer 10 and/or hub module.

The computer 10 facilitates analysis of the sensor information. The computer 10 includes at least a processor communicatively coupled to a memory location. The computer 10 facilitates analysis of the sensor information using an analysis module 16 configured to receive some or all of the sensor information, process the sensor information, and generate a first result used in determining a recommended training output to the user, such as a report or lesson governed by a learning plan. The analysis module 16 may optionally include a filter configured to reformat sensor information so that it is suitable for use by the analysis module 16, for example to place the sensor information in a structured data format indicating the nature of each physical expression correlated with the time each such expression occurred.

The analysis module 16 may process sensor information to generate a first result by executing a series of logical tests, comparison of such information against a set of rules contained in the analysis module 16, and/or comparison against other stored data 18. The tests, rules, and other stored data 18 may be stored upon installation, input by a user, and/or provided to the computer 10 through download and/or upgrade/update. The stored data 18 may further be “taught” and refined using the computer 10 or external system. Refining the tests, rules and other stored data 18 may rely on internal or external processes, information obtained through use of the sensor 12 or imported from an external system into the computer 10.

The tests and rules of the analysis module 16 and the other stored data 18 may be upgraded or updated via the computer 10 communicating with an external system such as an external computer system or mass storage device, and/or via collection of user data through the sensor 12. Communications between the computer 10 and external systems may be managed by a hub module 20. The hub module 20 is configured to manage communications between external systems and systems responsible for managing the sensor 12 and/or the display 14, which in a preferred embodiment include the computer 10. Via the hub module 20, the computer 10 may, for example, receive updates or upgrades for its software or the analysis module 16, receive data and software code for inclusion in the stored data 18, and provide sensor information, training output 22 and/or results to external systems for additional processing or storage, and facilitate communication of results of such additional processing. The hub module 20 and/or computer 10 may be hosted locally in proximity with the sensor 12 and display 14, or may be hosted remotely, for example as part of a cloud-based computing system. “External systems” as used herein, refers to one or more memory locations that may be communicatively coupled to one or more processors and that are modified by instructions that originate with other than the user, computer or sensor to store information, data and/or code. For the avoidance of doubt, such instructions to modify the memory locations may “originate” with other than the user, computer or sensor even if the computer 10 is the instrumentality that carries out such instructions. It is thus envisioned that the external systems may be executed on processors, or be located on computing devices, that are shared with the computer 10 without deviating from the spirit of the present inventive concept.

In a preferred embodiment, the hub module 20 manages communications with external systems via a communication network that may include a public computer network such as the Internet, in which case an optional firewall may be interposed between the communication network and the computer, and between the communication network and external systems. Alternatively, the communication network may be a private computer network such as a wireless telecommunication network, wide area network, or local area network, or a combination of networks.

Returning now to FIG. 1, utilizing the analysis module 16, the computer 10 creates a first result for use in generating training output 22. This first result may include a structured data set, a set of commands or software instructions such as executable code, a string of text or an audio or audiovisual file, an instruction to the computer 10 to access and display stored data 18 or to use the hub module 20 to access and/or generate additional information or data. The first result may still further include instructions to the computer 10 to export all or a portion of the first result, sensor information and/or stored data 18 to an external system via the hub module 20 for further analysis or feedback. The computer 10 may alternatively export results, sensor information and/or stored data 18 for alternative or parallel analysis, or for unrelated use in external systems, without instruction from the analysis module 16. Further, the external system(s) may provide a second result via the hub module 20 for use in the system, alone or in combination with the first result produced by the analysis module 16.

The first result obtained by the computer 10 through utilizing the analysis module 16, and/or the second result obtained from external systems utilizing the hub module 20, are used for transmission of training output 22 by the display 14. The first result and second result may be complimentary, and/or may require further processing in view of one another to form the training output 22. The first and second results may already be formatted for submission to the display 14 to instruct training output 22 transmission. The results may alternatively require pre-processing by the computer 10, which may include compiling instructions, files or information, to form suitable instructions formatted to be submitted to the display 14. In either case, the first and/or second results are provided to the display 14, and the display 14 transmits training output 22 to the user based thereon. Training output 22 includes, for example, real-time feedback such as auditory or visual suggestions of how the user should change movements or tones, breathe more deeply, relax facial muscles, reduce volume of speech and make other such adjustments; simple real-time feedback such as temporary screen color changes to indicate whether particular physical expressions were desirable or not; scorecards or progress reports; training videos or audio files pre-recorded and played for the user; real-time video or audio links to external systems that may feature an expert for providing instruction; and even playback of videos or audio files showing the user's physical expression(s) and indicating adjustments that should be made.

Turning now to FIG. 2, a process according to an embodiment of the present inventive concept is presented. At step 200, the display prompts a user to begin physical expression. The prompt may be set to request a specific physical expression or series of physical expressions, such as a three minute presentation, singing of a particular song, or performing a set of movements useful in the cutting of hair. The user may already be aware based on context or past practice of the expected physical expression, in which case the display prompt 200 may simply be a cue for the user to begin consisting of an audio or visual cue or a combination of such output. In other embodiments, the computer and sensor may be configured to sense the initiation of input from a user, thus automatically triggering the system and beginning a process according to the present inventive concept. Further, the computer and/or sensor may be configured to recognize a user's spontaneous input as falling within the expertise of a certain program accessible to the analysis module, so that once a user performs one or more physical expressions, prompted or unprompted, the computer is capable of gathering the appropriate sensor information and assigning the appropriate tasks for an analysis module to perform during analysis. For example, the user may spontaneously initiate a song performance input, triggering generation of sensor information by the system, and the computer may be configured to recognize the song performance input and assign the appropriate analyzing task to the analysis module or the computer may execute the analysis module and the analysis module may determine the appropriate analysis which should be undertaken to produce a first result.

At step 210, the sensor transmits sensor information to the computer via any of a variety of known methods, including wireless or wired transmission. At step 220, the computer executes the analysis module according to its rules and parameters. The analysis module may direct the computer to access the hub module for sending sensor information and results to an external system, and receiving any results or information/data from an external system. The analysis module also analyzes the sensor information to generate results. During the analysis, the analysis module may access stored data including information such as baseline data gathered from past physical expressions of the user, information about relevant physical expressions of others, or other relevant data or instructions. The analysis module may also instruct the computer to access data and/or instructions received via the hub module.

At step 230, the analysis module generates results, which may also be combined with and/or rely upon results or information received via the hub module. For example, analysis of the sensor information may have involved accessing the stored data, such as baseline information from past user physical expressions, and generating a score to show changes from past sessions. The analysis module may have also instructed the computer to send the sensor information via the hub module to an external system for a “second opinion” of sorts that may be based on comparison with data from other persons and/or a theoretical model. Data from or regarding other persons includes data regarding similar performances of other persons recorded in a structured data format, such as feedback data relating to such performances, data regarding persons of similar archetypes and their performance(s), data regarding the efficacy of certain training output in improving the performance of other persons, and/or data from other persons' profiles. These two results, i.e., the score generated by the analysis module and the “second opinion”, may be combined into one weighted score, or kept as separate training output for the user. Still further, the analysis module may have requested certain training files, lesson plans or audiovisual materials be incorporated into the training output, and those materials may be stored data and/or be provided via the hub module, or the analysis module may have requested a live audio or audiovisual link be established with another person such as an instructor. In addition, the external system(s) may have sufficient permission to bypass the computer and directly transmit results, such as instructions, to the display for use in providing the training output. The results of the analysis module and those obtained from an external system may also include instructions for adjustment of the sensor, for example, to improve or personalize collection of sensor information and data.

At step 240, the results are sent to the display and the display transmits the training output to the user. In a preferred embodiment, in step 250 the results include a prompt for the user to choose whether he/she wishes to retry the last session and erase the sensor information and results from stored data (and any changes to the rules or algorithms of the analysis module, stored data, or exported data that may have resulted from that session), engage in another session while keeping the aforementioned changes and data intact, or not to continue. In addition, a user may be given the choice to adjust expectations against which the sensor information is compared during generation of a result, for example the user may have been aspiring to a “perfect” standard but, after several sessions in which he/she was only able to obtain a score of “adequate”, decide to adjust the standard expectations to a middle ground of “good”.

Further, in certain embodiments the system and method may permit users or third parties to define certain elements of the rules, algorithms and other data used by the analysis module for analyzing the sensor information, or that are used by external systems in providing a second result or feedback. For example, the system and method may be employed in an “enterprise” or other setting in which certain users (administrators, who may be the end users themselves) are designated and permitted access to set parameters and goals, and perhaps review the progress of, end users. Such administrators may be enabled in the system, and indeed may be prompted by the system, to modify rules and provide other customized stored data to guide their own enterprise users according to internal goals. For example, a program administrator within a company may want to select certain words that are critical to the company's goals and direct the system to provide positive feedback and assessments for, and emphasize learning plans incentivizing, use of such words. Similarly, certain movements and patterns may be particularly useful in a given industry, such as emphatic hand gestures, and the program administrator may wish to direct the system to reward such gestures. Alternatively, the administrator(s) may select physical expressions or patterns that should be minimized by users. This selection and customization process may be prompted by the system, for example according to archetype or industry setting, or may be initiated by administrator(s) by, for example, selecting appropriate options provided within the dashboard discussed below.

Turning now to FIG. 3, a flowchart is shown detailing generation of results that define training output according to an aspect of the present inventive concept. The analysis module 300 of FIG. 3 triggers transmission of training output 302 based on the passage of time or other program parameters, user prompting, and/or external prompting. For example, training output 302 may be scheduled for periodic transmission according to a schedule of a user's training program, or may be triggered by reaching a particular milestone within the learning plan or by the detected presence of the user in proximity to the sensor. The user may also activate the system, thus causing training output 302 to be transmitted. In another embodiment, a hub module 310 may activate the display directly or through coordination with the analysis module 300 to transmit training output 302 according to similar triggering factors to those described in this paragraph.

Certain content of the training output 302 may be directly derived from the results provided by the analysis module 300 and/or the hub module 310 in certain embodiments, and other content may be indirectly derived from such results such as where the results are taken into consideration in formation of a learning plan and the training output 302 is derived from the learning plan. In a preferred embodiment, the analysis module 300 includes executable code configured to receive sensor information, obtain data and software updates and code from the stored data 304 and hub module 310, and to process the foregoing to generate a first result and/or instructions for the hub module 310. The hub module 310 facilitates communications with third party users and external systems, including to facilitate execution of one or more external analysis modules to produce a second result. The hub module 310 also communicates data and software updates to the computer for updating the analysis module 300 and/or the stored data 304.

In an embodiment of the present inventive concept, sensor information, which may be overlaid with file headers or other metadata or instructions provided by the analysis module 300, is communicated to the hub module 310 for transmission to third party users. The third party users may review the sensor and related information, for example on their own personal computers or mobile devices, and provide feedback to the hub module 310 for transmission to the analysis module 300, and such feedback may be incorporated into the results that contribute to the training output 302 and may also be incorporated into the stored data 304. The sensor and related information may be displayed to the third party users that are communicatively coupled to the external system(s) as a recording of the physical expressions of the user, as a structured data set representing such physical expressions along a timeline, or as an abstraction of such physical expressions, for example through conversion of an audiovisual recording of the user to an animated and de-identified audiovisual representation of those physical expressions. The feedback may be solicited and structured in any of a variety of ways, for example the third party users may be prompted to select one or more words from a collection of words to indicate their responses to the sensor information at one or more during display of the sensor information, or may be asked to identify deficiencies in the users physical expressions using a scale or similar system. The feedback may be used to refine the algorithm of the analysis module 300 or external systems, and/or may be combined with other feedback, data and/or a first result and taken into account during formation of a learning plan.

Further, sensor and related information, or instructions related thereto, may be provided via the hub module 310 for analysis by external system analysis modules, with the output of such analyses forming a second result fed directly to the display and/or input into the analysis module 300 for combination or coordination with the first result.

The training output 302 is driven by a first and/or second result obtained from the analysis module 300 and/or hub module 310, and in preferred embodiments also by a longer-term learning plan formulated for the user. The results are a set of instructions and data that may reflect performances and progress reports, and may instruct execution of a portion of a learning plan that is to be conveyed during a discrete period of time to the user as training output 302. The results reflect comparisons of sensor information (which may include structured data derived therefrom for processing) with stored data 304, including algorithms weighted and refined using human knowledge regarding physical expression, data obtained from the hub module 310, and/or sensor information processed by external systems via the hub module 310. The comparison contrasts the sensor information with physical expressions or patterns of physical expression that are deemed desirable. A single expression, such as a gesture, posture, word or pitch change, may be processed and determined to be undesirable based merely on its occurrence, while the desirability of another expression may be judged based at least in part on the expressions that surround it and other contextual concerns. For example, less sustained eye contact may be desirable during a pregnant pause of appropriate length for the provision of emphasis, while such eye contact may be undesirable during a period of unbroken speech. Similarly, because the system of the present inventive concept also detects and analyzes words and verbal information, the saying of a particular word or phrase may be considered desirable or undesirable depending heavily on the context and timing of the saying, for example when considered in connection with accompanying hand movements and other gestures and expressions. The algorithms of the analysis module 300 and external systems reached via the hub module 310 are thus complex and capable of adjustment to take into account a variety of variables, patterns and contexts.

The rules, tests, algorithms and data relied on by the analysis module 300 and external modules for comparison with sensor information are continually updated and revised based on internal sensor information retrieved via the system's sensor, and external information obtained via the hub module 310. Where isolated sessions are undertaken by a user, the comparison of sensor information against such stored and external data may simply result in a “snapshot” training output 302, for example a report or real-time instruction, that identify deficiencies in the users performance and outlines methods for improvement. However, in a preferred embodiment, the training output 302 is derived from and forms a part of a larger learning plan. The learning plan tracks a users performance over time, and adjusts the training output 302 to create a personalized plan that may be updated from time to time by system algorithms, and/or by plan administrators that access and review such users performance.

The rules, tests and data used for comparison against sensor information, and the algorithms of the analysis module 300 and of external modules, may be configured to recognize and take into account particular user archetypes to facilitate creation of a learning plan. A variety of archetypes may be defined to categorize individual users as similar to other known users or types of users, and thus provide predictive functionality with respect to expected progress and patterns, and methods that may be effective to incorporate into an individual's learning plan. For example, a users profile may contain certain information regarding that person's career, income, education level, and other characteristics, and that user may perform a baseline presentation or other series of movements to provide the system with information regarding the users current level of abilities. Some or all of that information may be used to classify the user in one or more archetypes, thus facilitating creation of goals more personalized to that user and of a learning plan more likely to be effective for said archetype. User profiles may be part of the stored data, and be used in a variety of ways to track and display users' progress, learning plan progress, and historical performance information, and to facilitate formation of a learning plan.

The system of the present inventive concept may additionally feature a customized user dashboard interface from which the user may access reports of prior performances and sessions, previous training output, feedback from third party users, and/or summaries of learning plans. The dashboard may also provide the user with information regarding similar successes or failures experienced by others, including those categorized in the same or similar archetypes. The dashboard may further provide access to a predictive modeling output that will predict the users future performance.

Information and signals may be represented using any of a variety of different technologies and techniques. For example, data, instructions, commands, information, signals, bits, symbols, and/or chips referenced herein may be represented by voltages, currents, electromagnetic waves, magnetic fields or particles, optical fields or particles, and/or any combination thereof. Such information and signals may further undergo reformatting such as by device drivers and similar software tools to enable successful communication between components of the system.

Various illustrative logical blocks, modules, circuits, and/or algorithm steps described in connection with the embodiments disclosed herein may be implemented as electronic hardware, computer software, and/or combinations of both. To clearly indicate the interchangeability of hardware and software, various illustrative components, blocks, modules, circuits, and steps have been described above generally in terms of their functionality. Whether such functionality is implemented as hardware or software depends upon the particular application and design constraints imposed on the overall system. The functionality of the present inventive concept may be implemented in various ways for each particular application without deviating from the scope of the present inventive concept.

The various illustrative logical blocks, modules, and circuits of the present inventive concept may be implemented or performed with a general purpose processor, a digital signal processor (DSP), an application specific integrated circuit (ASIC), a field programmable gate array (FPGA) or other programmable logic device, discrete gate or transistor logic, discrete hardware components, and/or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, and/or any other such configuration.

The steps of a method or algorithm described in connection with the embodiments of the present inventive concept disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of embodiments of the presently disclosed inventive concept is provided to enable any person skilled in the art to make or use the present inventive concept. Various modifications will be readily apparent to those skilled in the art, and the generic principles defined herein may be applied alternatively without departing from the spirit or scope of the present inventive concept. Thus, the present inventive concept is not intended to be limited to the description herein but is to be accorded the widest scope consistent with the principles and novel features disclosed herein.

Though the embodiments described herein refer to a computer communicatively coupled to a hub module that is communicatively coupled to one or more external systems, it is envisioned that the computer, analysis module, and/or stored data may reside remotely from the sensor and display without departing from the spirit of the present inventive concept. In such cases, the sensor information and results may be exchanged between the sensor and display on the one hand, and the remote computer, analysis module, stored data and hub module on the other, via a communication network. In an embodiment of the present inventive concept then, the computer, analysis module, stored data and hub module may reside remotely on one or more devices such as in a cloud hosting system without departing from the spirit of the present inventive concept.

Method steps performed by the system of the present inventive concept as described herein may be interchanged without deviating from the scope of the present inventive concept.

Having now described the features, discoveries and principles of embodiments of the present inventive aspect of this disclosure, the manner in which embodiments of the present inventive aspect are constructed and used, the characteristics of such construction, and advantageous, new and useful results obtained; the new and useful structures, devices, elements, arrangements, parts and combinations, are set forth in the appended claims.

It is also to be understood that the following claims are intended to cover all of the generic and specific features of the present inventive aspect herein described, and all statements of the scope of the present inventive aspect which, as a matter of language, might be said to fall there between.

What is claimed is:

1. A system configured to provide physical expression training to a user comprising:
a computer;
a sensor configured to: (i) detect a physical expression of the user, and (ii) provide sensor information regarding the physical expression to the computer;
an analysis module configured to analyze the sensor information and generate a first result; and
a display configured to transmit training output to the user.

2. The system according to claim 1, further comprising stored data configured to be accessed by the computer in connection with analysis performed by the analysis module.

3. The system according to claim 2, wherein the stored data includes at least one of (i) data regarding the user, (ii) data regarding other persons, (iii) data provided by a hub module, (iv) code provided by the hub module, and (v) data provided by an administrator.

4. The system according to claim 1, further comprising a hub module configured to manage communications between the computer and an external computer system.

5. The system according to claim 4, wherein the training output is derived from at least one of (i) the first result and (ii) a second result received via the hub module.

6. The system according to claim 4, wherein the training output is derived from the first result and a second result received via the hub module.

7. The system according to claim 5, wherein the training output is derived from the second result and the second result is feedback provided by third party users relating to the sensor information.

8. A computerized method for providing physical expression training to a user comprising the steps of:
receiving sensor information regarding the physical expression of the user;
analyzing the sensor information using a computer and an analysis module to generate a first result; and
transmitting training output to the user via a display.

9. The computerized method according to claim 8, wherein analyzing the sensor information includes accessing stored data.

10. The computerized method according to claim 9, further comprising the step of:
acquiring stored data regarding other persons via a hub module.

11. The computerized method according to claim 8, further comprising the step of:
acquiring a software update for the analysis module via a hub module.

12. The computerized method according to claim 8, further comprising the step of generating the training output using the first result.

13. The computerized method according to claim 8, further comprising the step of generating the training output using a second result received via a hub module.

14. The computerized method according to claim 13, wherein the second result includes feedback provided by third party users relating to the sensor information.

15. A computerized method for improving stored data relating to the desirability of physical expression patterns, the steps of the method comprising:
receiving sensor information regarding the physical expression of the user;
analyzing the sensor information using a computer and an analysis module to generate a first result;
transmitting training output to the user via a display; and
storing the sensor information and training output in a stored data.

16. The computerized method according to claim 15, wherein analyzing the sensor information includes accessing stored data.

17. The computerized method according to claim 15, further comprising the step of:
acquiring the stored data regarding other persons via a hub module.

18. The computerized method according to claim 15, further comprising the step of:
acquiring a software update for the analysis module via a hub module.

19. The computerized method according to claim 15, further comprising the step of generating the training output using a second result received via a hub module.

20. The computerized method according to claim 19, wherein the second result includes feedback provided by third party users relating to the sensor information.

21. The computerized method according to claim 15, further comprising the step of permitting an administrator to input stored data.

22. The computerized method according to claim 20, wherein the sensor information is animated and de-identified prior to feedback being provided by the third party users.
